(19) United States
(12) Patent Application Publication
(10) Pub. No.: US 2004/0253390 A1
(43) Pub. Date: Dec. 16, 2004

(54) Practice mat simulating grass thatch and blades of golf course lies

(76) Inventor: Scott Trafford, Westlake Village, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/459,256

(22) Filed: Jun. 10, 2003

(51) Int. Cl. A41G 1/00; A01N 3/00

(52) U.S. Cl. 428/17; 428/23

(57) ABSTRACT

A golf practice mat provides, on an upfacing surface, a plurality of mutually aligned artificial grass blades that extend upwardly. The grass blades include a portion of longer fixed length and a portion of shorter fixed length. The longer blades second angle exceeds the first angle. The ends of the longer blades extend above the ends of the shorter blades. The shorter blades have a longitudinal rigidity and density of placement on the practice mat so as to support a golf ball at a desired height above the practice mat; the height determined primarily by the shorter blades. The longer blades have a flexibility and density of placement on the mat that provides a natural feel to a golf club driving through the blades.

### BACKGROUND OF THE INVENTION

### INCORPORATION BY REFERENCE

Applicant(s) hereby incorporate herein by reference, any and all U.S. patents, U.S. patent applications, and other documents and printed matter cited or referred to in this application.

1. Field of the Invention

This invention relates generally to artificial surfaces used in the sport of golf and more particularly to a practice mat that is able to provide support to a golf ball in a realistic manner and to allow movement of a golf club head through the practice mat surface during a stroke with a realistic feel.

2. Description of Related Art

The following art defines the present state of this field:

Miraflor, U.S. Des. 443,909 describes a multiple texture artificial turf golf practice pad design.

Lester, U.S. Pat. No. 3,143,350 describes a golf practice mat comprising a sheet of flexible material and an array of a plurality of closely spaced elongated flexible supports integral with and arising from each side of said sheet, said sheet and said supports constituting a -unitary molding, an elastic tether secured to said sheet for fastening the mat to the ground with said mat supported in position on the ground with one of said arrays of flexible supports upper-most for supporting a golf ball and with the other array lower-most and acting as a cushion under said sheet, said sheet having an end with an inclined extension in position to guide a golf ball from the ground level to the top of said upper-most array.

Mitchell, U.S. Pat. No. 3,414,266 describes a golf putting practice rug consisting essentially of distinct first, second and third elongated strips of pile fabric disposed in side-by-side relationship, said second strip being disposed between said first and third strips, a first distinct narrow strip of pile fabric secured to and between the adjacent side-by-side edges of said first and second elongated strips and a second distinct narrow strip of pile fabric secured to and between the adjacent side-by-side edges of said second and third elongated strips, the color of said narrow strips being different from the elongated strips secured thereto so that lines of demarcation between said connected elongated strips may be seen, the length of the pile forming said first, second and third elongated strips being, respectively, about ten, fifteen and twenty millimeters whereby said rug provides a golfer with three distinct putting surfaces simulating a fast, normal and slow green.

Stephens et al., U.S. Pat. No. 3,565,742 describes a flocked product suitable for use as a synthetic golf green and having a substantially uniform deceleration modulus, said product having a surface composed of cut-pile thermoplastic ribbons vertically held in an adhesive backing, said ribbons being characterized by a width to thickness ratio of about 10 to 1 and a denier of about 250 to 750 and being randomly dispersed in said backing to provide a substantially non-directional response to an object rolled across said surface.

Kolonel, U.S. Pat. No. 3,669,454 describes a golf-putting mat for both indoor and outdoor use in which grass-simulating mat material has directionally oriented pile that resists the motion of the ball in one longitudinal direction of the mat more than in the reverse direction. Natural slow and fast conditions are obtained by using monofilament synthetic fibers 2 to 10 mils in diameter, with 2,000 to 8,000 fibers per square inch extending on-eighth to three-eights inches above the mat backing and oriented between 5 degrees and 15 degrees off normal. Detachable or nondetachable putting holes are provided at both ends of the mat.

Nadler, U.S. Pat. No. 3,673,056 describes a product having a turf-like appearance and useful as a playing field surface for football, baseball, or other games that can be made in a wide variety of blade patterns and textures by (a) providing a liquid layer of polymeric matrix material (e.g., a foamable polyurethane composition) which can be solidified in situ to a desired degree of resilience add toughness; (b) providing a number of flexible polymeric ribbons; (c) making numerous width-wise cuts in one edge of each ribbon so as, to form numerous blades (grass-bladelike elements) which are fastened together at their base; (d) forming a composite structure in which the ribbons are closely-spaced and in embedded relation with the liquid matrix layer whereby each ribbon has its length-parallel with the matrix layer, its width perpendicular thereto, its blades upstanding therefrom, and a lower portion embedded therein; and (e) causing the matrix layer to solidify in situ.

Anderson et al., U.S. Pat. No. 3,740,303 describes an artificial grass mat having an upper cut pile layer of nylon fibers tufted through a backing fabric to form a grass-like surface, the improvement for providing resilience characteristics of a high-quality natural-golf green wherein the improvement comprises a cut pile layer, having a nylon pile ⅜ to 1/2 inch in height and weighing about 27 ounces per square yard, uniformly adhered to the upper surface of a needled nonwoven batt about ⅜-¾-inch thick composed of 10 to 50 denier polyethylene terephthalate fibers, having 3 to 10 crimps per inch and a Busse Recovery between 30 and 40, bonded in position with acrylic resin in an amount of 20 to 50 percent by weight of the fibers in a batt having a density of about 1.88 to 3.75 pounds per cubic foot to provide a durable grass mat having a first bounce height averaging 10 to 25 percent in the ball bounce test and essentially zero bounce after a second bounce.

Wessells, U.S. Pat. No. 3,940,522 describes a cut pile fabric that is produced using a grass-like fiber and, optionally, a crimped or crimpable fiber of lower denier than said grass-like fiber plied therewith. The pile fabric made from such fibers has improved aesthetics (e.g., appearance) and mechanical (e.g., frictional) properties, and closely simulates natural turf.

Coonrod, U.S. Pat. No. 4,988,106 describes a portable, practice golf putting green presents realistic and challenging putting practice and in which all of the components can be formed into a convenient and compact storage position. The preferred putting green includes a flexible base of material presenting a playing surface providing two different resistances to the roll of a golf ball and realistically simulative of a putting green, a plurality of openings simulative of golf green cups defined in the playing surface, an elevated portion presenting one of the openings at an elevated level, and a pair of longitudinally and transversely adjustable wedges for selectively altering the contour of the playing surface.

Toikka, U.S. Pat. No. 5,354,064 describes a brush mat for simulating a grass rough and on which golf balls are placed for practice hitting by a golfer. The mat includes numerous upstanding fibers, simulating grass, in which the upper surface defined by the upper ends of the fibers is generally planar, except for one or more hollows formed in the upper surface. The hollow or hollows have selected depths to receive and hold golf balls, from which location or locations the ball would be hit. Providing different depths for the hollows in which the balls are placed, allows for simulating different rough conditions since the golf ball will protrude above the upper generally planar surface different distances for the different depth hollows.

Bair, U.S. Pat. No. 5,655,974 describes a golf ball playing surface assembly including a playing surface having a rectangular recess of predetermined depth, length and width; a plurality of different mats for selectively placing in the recess to simulate different playing conditions, each mat having at least one dimension less than a corresponding dimension of the recess, and whereby at least two mats placed side by side will substantially fill the recess with no gaps; and the mats including at least one mat having at least two different surface areas for simulating different golf playing surface conditions.

Jackson, Jr., U.S. Pat. No. 6,106,409 describes a multi-section golf practice mat including a mat having three indented sections formed therein in a spaced relationship. A first mat insert is provided having simulated grass extending outwardly therefrom. The first mat is removably received within a first of the three indented sections of the mat. The simulated grass of the first mat insert corresponds with fringe grass on a golf course. A second mat insert is provided having simulated grass extending outwardly therefrom. The second mat is removably received within a second of the three indented sections of the mat. The simulated grass of the second mat insert corresponding with fairway grass on a golf course. A third mat insert is provided having simulated grass extending outwardly therefrom. The third mat is removably received within a third of the three indented sections of the mat. The simulated grass of the third mat insert corresponds with rough grass on a golf course.

Bergevin, U.S. Pat. No. 6,295,756 describes an improved playing surface including a synthetic turf base positioned atop a foundation. The synthetic turf base includes synthetic fibers secured to a backing material. The synthetic turf base also includes a surface layer of growth medium applied on top of the backing material to reach a predetermined depth. Natural grass is planted in the surface layer of growth medium. The backing is provided with perforations or openings sufficient in number to permit the roots of the natural grass to extend through the backing into the sub-base of the foundation.

Sosin, U.S. Pat. No. 2002/0,091,011 describes an artificial turf made from fibers that include chromogens. The fibers and hence the chromogens experience stress and/or heat in response to being struck (e.g., by a golf club), and thereby provide visual feedback of the location and direction of the impact. The golf club head may be coated with a chemical or solvent that causes a chromogen to change color. The turf can be used to provide feedback about where a divot would occur if a golfer were playing on grass. In addition, it can be used to make line calls or to mark impacts in other sports such as tennis, football, cricket, and in track and field events. Also a color changing material that includes a substrate and a film disposed on a surface of the substrate, the film including a chromogen.

The prior art teaches a multiple texture artificial turf golf practice pad; a golf practice mat and a putting rug; a flocked golf green; a two-speed golf mat; a turf-like product and method of making it; an artificial playing surface; synthetic fibers and pile fabrics made from the fibers; a golf putting green; a golf ball striking mat and a playing surface; a multi-section golf practice mat; a sports surface; and an impact roll measurement device. The prior art, however, does not teach a golf practice mat that provides for realistic ball support as well as realistic feel during the stroke. The present invention fulfills these needs and provides further related advantages as described in the following summary.

### SUMMARY OF THE INVENTION

The present invention teaches certain benefits in construction and use which give rise to the objectives described below.

The present invention is a golf practice mat providing, on an upfacing surface, a plurality of mutually aligned artificial grass blades that extend upwardly. The grass blades include a portion of longer fixed length and a portion of shorter fixed length. The longer blades are set at a first angle, while the shorter grass blades are set at a second angle where the second angle exceeds the first. However, the tips of the longer blades extend above the tips of the shorter blades. The shorter blades have a longitudinal rigidity and density of placement on the practice mat that is adequate for supporting a golf ball at a height above the mat; the height determined primarily by the shorter blades. The longer blades have a flexibility and density of placement on the mat that is adequate for providing a natural feel to a golf club driving through the longer blades.

A primary objective of the present invention is to provide an apparatus and method of use of such apparatus that provides advantages not taught by the prior art.

Another objective is to provide such an invention capable of simulating the feel of a golf swing, when the ball is resting on the fairway or in the rough.

A further objective is to provide such an invention capable of use with minimual damage to artificial grass blades thereof.

A still further objective is to provide such an invention capable of low cost manufacture.

A yet further objective is to provide such an invention wherein worn spots may be selectively removed and replaced.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of the preferred embodiment of the invention; and

FIG. 2 is a plan view thereof.

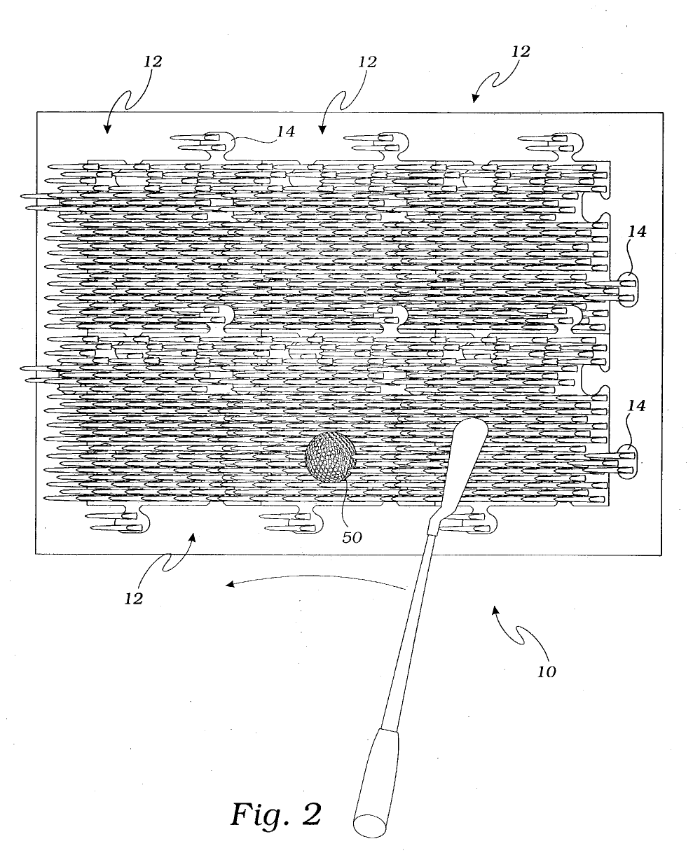

### DETAILED DESCRIPTION OF THE INVENTION

The above described drawing figures illustrate the invention in at least one of its preferred embodiments, which is further defined in detail in the following description.

In the sport of golf, a golf club is used to hit a golf ball that typically lies on, or in, grass on a dirt base surface. Therefore, an earthen base supports a grass thatch from which grass blades extend upwardly. A proper stroke of the golf club finds the ball contacting a golf club head near its center of mass which places the bottom of the club head below the ball. Thus, a divot is cut from the grass thatch and usually is projected forward of the ball. The divot comprises a portion of the grass thatch, dirt adhering to the thatch's root system on the divot's bottom, and grass blades that are growing above and out of the thatch. The thatch and its upwardly extending blades, as well as the ball itself, of course, provide a resistance to the club head's movement during the stroke. The present invention simulates this resistance artificially during practice, as for instance at a golf driving range. The present invention provides an artificial grass that supports the golf ball at a preferred level above a solid base and also provides a simulated resistance to movement of the golf club head during the stroke.

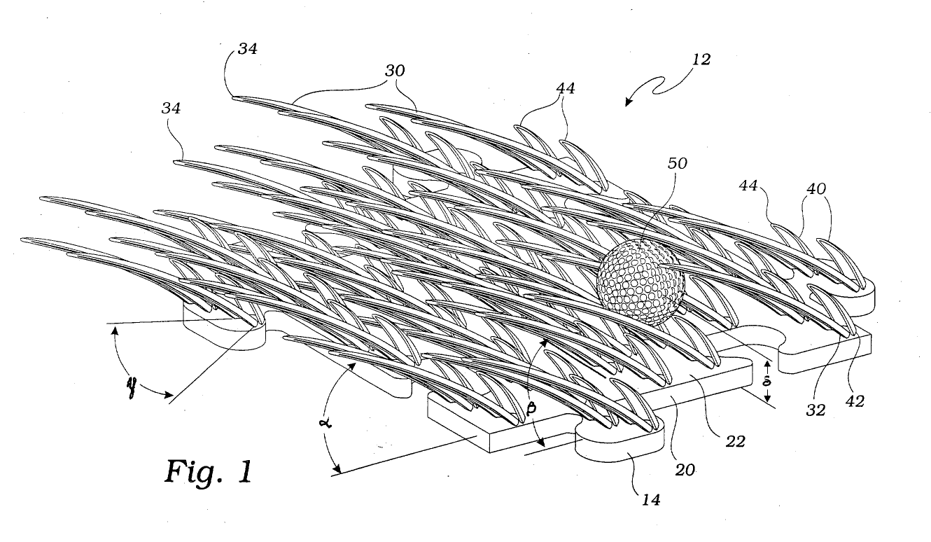

The golf ball is normally elevated above the dirt surface by up to about one inch, and the golf club head finds resistance as it moves through the thatch and grass blades. In the present invention a golf practice mat apparatus 10 comprises a horizontally oriented foundation pad 20 which may be placed on any solid surface for support. The pad 20 has an upfacing surface 22 engaging the ends of a plurality of mutually aligned artificial grass blades, the blades extending upwardly from the foundation pad 20, as shown in FIG. 1. The grass blades include a longer fixed length portion 30 of the grass blades, and a shorter fixed length portion 40 of the grass blades. All of the blades 30, 40 are either of the longer 30 or the shorter 40 variety. The longer blades 30 are set at a first selected angle α, preferably about 30-40 degrees above horizontal, while the shorter blades 40 are set at a second selected angle β, preferably about 55-70 degrees above the horizontal. These angles have been found to be critical to the operation of the invention and in meeting its objectives. This is clearly shown in FIG. 1. The angle β exceeds the angle α so that the shorter blades 40 stand more erectly than the longer blades 30 and are more rigid; tips 34 of the longer blades 30, however, extend above the tips 44 of the shorter blades 40. The shorter blades 40 have a selected longitudinal blade rigidity, and are placed in a density on the pad 20 that is adequate for supporting a golf ball 50 at a chosen height ∂ above the upfacing surface 22, said height a being determined primarily by the shorter 40 of the grass blades and is preferably in the range of 1-2 inches. This length has been found to be critical to the proper support of the golf ball. The longer 30 of the grass blades have a selected longitudinal flexibility are placed on the pad 20 in a density that is adequate for providing a natural feel to a golf club driving through the longer ones 30 of the grass blades. The shorter 40 of the blades simulates the grass thatch one might find on a golf course, and as such simulates the resistance of the thatch to the golf club. The longer 30 of the blades simulates the grass blades that extend above the thatch. Clearly, longer blades 30 may be provided in various lengths to simulate various conditions of rough. In practice, the golf club head is driven through both the shorter 40 and the longer 30 of the blades to simulate cutting through thatch as well as natural grass blades. It is noted that all of the blades 30, 40 are aligned in a common direction, that is, the direction indicated by the movement of the golf club during its stroke. This provides the advantage of enabling significant resistance to club movement while preventing blade damage from the golf club, and is critical to the operation of the invention and to meeting the objectives thereof.

Preferably, the pluralities of shorter 40 and longer 30 grass blades are equal in number and paired, with each one of the longer grass blades 30 joined with one of the shorter grass blades 40 at the bases thereof, 32 and 42 respectively. This pairing is not necessary but provides for lower cost in manufacture when both blades are molded as a unit.

Preferably, the grass blades 30, 40 are formed of a plastic material, such as polyester or polypropylene or similar artificial structural materials, and with a thickness of between 0.001 and 0.010 inches which may vary from base to tip, and both of the blades are transversely arcuate, as shown in FIG. 1, having a concave surface facing downwardly with an included arc angle γ of approximately 40 to 50 degrees. The blades 30, 40 also preferably have a longitudinal taper, being wider at their bases 32, 42, and narrower at their tips 34, 44. The magnitude of the arc, length of the blades, degree of taper, stiffness coefficient and weight density of the plastic material all are contributing factors in determining the strength and flexibility of the blades, and therefore their usefulness in the present application. Each of these factors may be adjusted as desired to provide a ball support height and resistance to the golf club as desired, but the use of two blades in combination with each of the two blades tilted toward the pin provides a unique solution to the attainment of a realistic simulation in practicing the golf swing. Clearly, the use of “flexibility” and “rigidity” both refer to the same characteristic, i.e., stiffness, but the use of “flexibility” for the longer blades 30 is indicative of the fact that the longer blades 30 function, in this invention, to provide a realistic resistance to the club head and a feel to the golfer as his/her golf club slices through the longer blades 30, which move aside. The shorter blades 40 also move aside as the club head moves through the shorter blades 40, and provide the necessary resistance to simulate cutting thatch. Also, the shorter blades 40 provide support to the golf ball 50 so that the ball is able to be placed at a proper height above ground level prior to the stroke. It should be noted that the blades 30, 40 may be anchored into the pad 20 in any manner desired including in any way shown in the references which are listed above.

Preferably, the practice mat 10 is comprised of plural mat sections 12, which are mutually removably engaged by an edge engagement means 14 such as mutually engaged fingers, with each one of the mat sections 12 removable from the practice mat 10 by disengagement of the fingers 14.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A golf practice mat apparatus comprising: a horizontally oriented foundation pad, an upfacing surface thereof engaging bases of a plurality of mutually aligned artificial grass blades extending upwardly from the foundation pad and angled in a common direction; the plurality of grass blades exclusively including a longer fixed length portion of the grass blades and a shorter fixed length portion of the grass blades; the longer ones of the grass blades set at a first selected angle above horizontal; the shorter ones of the grass blades set at a second selected angle above horizontal, the second selected angle exceeding the first selected angle; portions of the longer ones of the grass blades extending above the shorter grass blades; the shorter ones of the grass blades having a selected longitudinal rigidity and placement density enabling supporting of a golf ball at a height above the foundation pad, said height determined primarily by the shorter ones of the grass blades; the longer ones of the grass blades having a selected longitudinal flexibility and placement density enabling a natural feel to a golf club driving through the the grass blades.

2. The apparatus of claim 1 wherein the pluralities of shorter and longer grass blades are equal in number and paired, with each one of the longer grass blades joined with one of the shorter grass blades at bases thereof.

3. The apparatus of claim 1 wherein the grass blades are formed of a plastic material.

4. The apparatus of claim 3 wherein the grass blades are transversely arcuate and longitudinally tapered, said arcuate and tapered shape enabling the longitudinal flexibility of the longer of the grass blades and the longitudinal rigidity of the shorter of the grass blades.

5. The apparatus of claim 1 wherein the pad is comprised of plural pad sections mutually removably engaged by an edge engagement means, with each one of the pad sections removable from the pad by disengagement of the edge engagement means corresponding thereto.

6. The apparatus of claim 1 wherein the shorter blades are less than 2 inches in length.

7. The apparatus of claim 1 wherein the shorter of the blades are set at an angle of between 55 and 70 degrees above horizontal.

8. The apparatus of claim 1 wherein the longer of the blades are set at an angle of between 30 and 40 degrees above horizontal.
